(19) United States
(12) Patent Application Publication
(10) Pub. No.: US 2007/0263483 A1
(43) Pub. Date: Nov. 15, 2007

(54) Introduction of additives into bulk polymer

(76) Inventors: Kenrick Venett, Blountville, TN (US); Bruce Roger DeBruin, Lexington, SC (US); David A. Sliger, Gray, TN (US)

Correspondence Address: Dennis V. Carmen;Eastman Chemical Company, P.O. Box 511, Kingsport, TN, 37662-5075, US

(21) Appl. No.: 11/431,236

(22) Filed: May 10, 2006

(51) Int. Cl. B01F 15/02

(52) U.S. Cl. 366/174.1; 366/182.1

(57) ABSTRACT

An apparatus for distributing a second material into a flow stream of a first material includes a distributor plate assembly coupled to an additive enriched stream. The distributor plate assembly is mounted within a vessel for a flow stream and distributes the additive enriched stream at various locations within the flow stream of the first material.

The present invention relates generally to liquid material mixing. More particularly, the present invention relates to an apparatus for distributing a first material into a flow stream of another material.

Mixing is central to a vast majority of processes including, for example(s), the chemical, pharmaceutical, food, water, and polymer processing industries. In some instances, it may be desirable to mix one material, such as a viscous material, into the flow stream, such as a bulk flow stream, of another material, which can also be viscous. (A bulk flow stream may include a main process stream of one liquid, such as a large liquid stream, which may receive one or more additional liquid stream(s), such as from one or more smaller liquid stream(s).) Processing equipment has been relied upon for facilitating mixing operations in order to generate desired mixes of materials. One example of processing equipment has included the use of static mixers within the aforementioned industries.

Static mixers have been commonly utilized, for example(s), within the food processing and/or polymer processing industries for mixing liquid materials. Such liquid flow materials may further posses various viscous properties. Thus, it may be desirable to mix two or more viscous materials, for instance, in a laminar flow process. This may include, for example, combining a liquid stream of viscous material into a liquid stream, such as a bulk flow stream, of another viscous material. It may be further desirable to achieve a degree of mixture of combined materials, such as viscous materials.

However, combining materials, for instance, by mixing a liquid stream into another liquid stream flow, such as a bulk liquid stream, utilizing a static mixer may generate some difficulties. For example, when utilized in a typical mixing operation, static mixers may be inclined to impede the flow of the materials being mixed. This effect may preclude a desired mix of proposed materials from being combined to a desired degree. Thus, in order to address restriction(s) to flow, one or more pumps may be utilized in line with the static mixer in an effort to overcome/compensate for any impedance of flow. However, the additional costs associated with providing supplemental equipment (such as the aforementioned pumps) can increase the overall cost required to produce a preferred mix of combined materials.

The present invention provides, in one aspect, an apparatus for distributing a second material into a flow stream of a first material. In some embodiments, the apparatus has a first plate with an inner surface and an outer surface. The outer surface has an opening for receiving the second material, and the inner surface has a plurality of channels disposed therein, wherein the plurality of channels is in communication with the opening. The apparatus may also include a second plate connected to the first plate to form a distribution plate assembly, wherein the second plate has an inner surface and an outer surface, and the inner surface of the second plate has a plurality of channels disposed therein. At least two of the plurality of channels of the second plate are aligned with at least two of the plurality of channels of the first plate to form at least two enclosed channels in communication with the opening. At least two of the plurality of channels of the second plate extend to outlet(s) on the outer surface of the second plate.

In accordance with another aspect of the present invention, a system for processing a liquid stream is provided that, in some embodiments, includes a first material, a vessel containing the first material, an inlet into the vessel for feeding a second material, and a distributor for distributing the second material coupled directly or indirectly to the inlet. The distributor may also distribute the second material at various locations into the liquid stream of the first material, wherein the distributor is mounted within the receiving means.

In accordance with another aspect of the present invention, a process for distributing an additive enriched second material into a flow of a first material is provided that, in some embodiments, includes a flow of a first material within a vessel and feeding the first material into one or more openings on a distributor located within a vessel without comingling the feed of the second material with the first material within the vessel. The process may also include the second material flowing through two or more of a plurality of channels within the distributor and being released through outlets located at various locations on the distributor into a liquid stream of the first material, wherein the number of outlets exceeds the number of openings on the distributor.

It is to be understood that both the foregoing general description and the following detailed description are exemplary and explanatory only and are not restrictive of the invention, as claimed.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

FIG. 1 is a schematic illustration of a commercial PET process according to an embodiment of the invention.

FIG. 2 is a cutaway view of a finishing tank according to an embodiment of the invention.

FIG. 3 illustrates a top view of the finishing tank shown in FIG. 2.

FIG. 4 illustrates a bottom view of a top plate for a distributor plate assembly according to an embodiment of the invention.

FIG. 4A illustrates a side view of the top plate shown in FIG. 4.

FIG. 4B is a detail view of a portion of the top plate shown in FIG. 4A.

FIG. 5 illustrates a top view of a bottom plate for a distributor plate assembly according to an embodiment of the invention.

FIG. 5A illustrates a side view of the bottom plate shown in FIG. 5.

FIG. 5B is a detail view of a portion of the bottom plate shown in FIG. 5A.

FIG. 6 illustrates a top view of an assembled distributor plate assembly according to an embodiment of the invention.

FIG. 6A illustrates a side view of the assembled distributor plate assembly shown in FIG. 6.

FIG. 7 is a perspective view illustrating the assembled distributor plate assembly shown in FIG. 6.

### DESCRIPTION OF THE EMBODIMENTS

The invention, in some embodiments, provides an apparatus for improving mixing of an added material to another material flow stream. Various embodiments of the invention will now be described with reference to the drawing figures, in which like reference numerals refer to like parts throughout.

As used in the specification and the appended claims, the singular forms “a”, “an” and “the” include plural referents. References to a composition containing “an” ingredient or “a” polymer or apparatus is intended to include other ingredients or other polymers or apparatus or feature, respectively, in addition to the one named.

Ranges may be expressed herein as “within” or “between” or from one value to another. In each case, the end points are included in the range. Ranges expressed as being greater than or less than a value exclude the end point(s).

By “comprising” or “containing” or “having” is meant that at least the named compound, element, particle, apparatus, or method step must be present in the composition or article or method or assembly or system, but does not exclude the presence of other compounds, materials, particles, method steps, or equipment even if the other such compounds, material, particles, method steps, or equipment have the same function as what is named.

Regardless of the context, the expression of a temperature means the temperature applied to the material, unless otherwise expressed as the “actual” material temperature.

It is also to be understood that the mention of one or more method steps or pieces of equipment does not preclude the presence of additional method steps or equipment, or intervening method steps or equipment between those steps or equipment expressly identified.

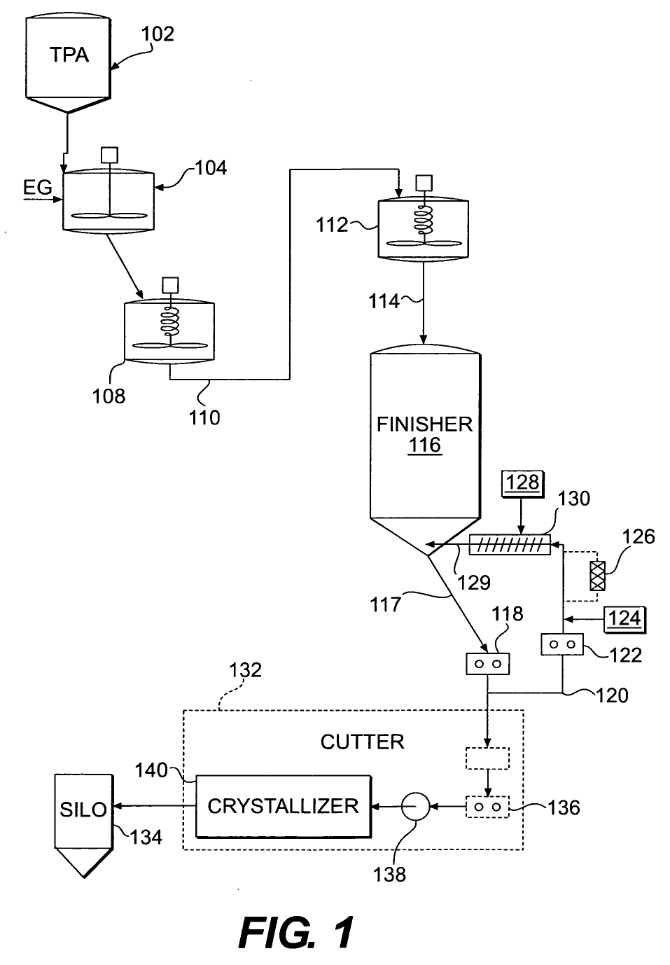

FIG. 1 illustrates a process 100 for processing polymers. A bulk polymer flow stream is created and introduced into a final reactor. In some embodiments, the polymer may comprise poly(ethylene terephthalate) (PET) as will be discussed, for example, with respect to FIG. 1 for illustrative purposes. However, it will be readily appreciated that the disclosure should not be limited by producing only PET, but, rather other polymers may be produced such as polyesters, polyamides, polyurethanes, polyolefins, or a copolymer thereof.

Thus, in one embodiment of a polymer development process, a reactant, such as terephthalic acid (TPA) 102, may be introduced and combined with ethylene glycol (EG) to create a paste at ambient temperature in a paste tank 104. The paste comprising mixtures of reactants may be subjected to various processes in order to produce a desired polymer for subsequent use. Such processes may include growing the monomer into an oligomer until such time when the oligomer forms into a polymer. To facilitate the formation of oligomer chains, the mixture of TPA and EG may be subjected to an esterification reaction in a vessel 108. As depicted, the vessel 108 may include a stirred tank reaction vessel, but is not limited to such a vessel. For example, the esterification, and for that matter, the polycondensation, may be conducted in a pipe reactor as described in U.S. Pat. No. 6,906,164 the full disclosures of which are fully incorporated herein by reference. In one embodiment, the esterification reaction conducted in vessel 108 may include subjecting the mixture of TPA and EG under positive pressure at a high temperature such as between 200° C. to 300° C., or at about 240° C. to 285° C., or at about 250° C., for about one to five hours, and at a super-atmospheric pressure of between about 1 psig up to about 70 psig. The residence time of the reactants may typically range from between about one and five hours. In some embodiments, the dicarboxylic acid(s) is/are directly esterified with diol(s) at elevated pressure and at a temperature of about 240° C. to about 285° C.

The esterification is typically continued until at least about 80% conversion, or at least 90% of the acid or ester groups are converted. The product of the esterification reaction may comprise an oligomeric mixture comprising the monomer bis(2-hydroxyethyl)terephthalate (BHET) along with a minor amount of oligomers and some unreacted reactants. The oligomeric mixture may include a typical degree of polymerization within a range of 2 to 8. The inherent and instrinsic viscosity of the oligomer mixture may typically be less than 0.1 dL/g.

Next, after the esterification reaction, the oligomeric mixture may be delivered via a pipe (110) to the polycondensation zone. Typical polycondensation reactions may occur at temperatures ranging from about 230° C. and 305° C., and at sub-atmospheric pressure of between about 350 mmHg to 0.2 mmHg. The residence time of the reactants may typically range from between about two to about six hours. In the polycondensation reaction, a significant amount of glycols may evolve by the condensation of the oligomeric ester species and during the course of molecular weight buildup.

As depicted in FIG. 1, the polycondensation zone may begin with a pre-polymerization vessel (or zone) 112 in order to build the molecular weight of the oligomeric mixture to begin forming polymers. In the prepolymerization zone, also known in the industry as the low polymerizer, the low molecular weight monomers and oligomers in the oligomeric mixture may be polymerized via polycondensation to form polyethylene terephthalate polyester (or PEN polyester) in the presence of a suitable polycondensation catalyst. The catalyst may be added to the esterification zone, at the initiation of the polycondensation zone, or to both or in between.

The prepolymer polycondensation stage may generally employ a series of one or more vessels and operate at a temperature of between about 230° C. and 305° C. for a period between about five minutes to four hours. During this stage, the It.V. of the monomers and oligomers may be increased generally up to about no more than 0.45 dUg. The diol byproduct may be removed from the prepolymer melt generally using an applied vacuum ranging from 4 to 200 torr to drive the polycondensation of the melt. In this regard, the polymer melt is sometimes agitated to promote the escape of the diol from the polymer melt. As the polymer melt is fed into successive vessels, the molecular weight and thus the melt viscosity, which is related to the intrinsic viscosity, of the polymer melt increases. The pressure of each vessel may be generally decreased to allow for a greater degree of polymerization in each successive vessel or in each successive zone within a vessel. To facilitate removal of glycols, water, alcohols, aldehydes, and other reaction products, the reactors may be typically run under a vacuum or purged with an inert gas. Inert gas is any gas which does not cause unwanted reaction or product characteristics at reaction conditions. Suitable gases include, but are not limited to, argon, helium, and nitrogen.

Once the desired It.V. in the prepolymerization zone is obtained, generally not greater than 0.45 dL/g, or not greater than 0.3 dUg, or not greater than about 0.2 dUg, the prepolymer may be fed via a conduit 114 from the prepolymer zone or vessel 112 to a finishing vessel or zone 116 where the second stage of polycondensation may be continued in one or more finishing vessels generally, but not necessarily, ramped up to higher temperatures than present in the prepolymerization zone, to a value within a range of from 250° C. to 310° C., more generally from 270° C. to 300° C., and at higher vacuum than the prepolymerization zone, until the It.V. of the melt is increased to an It.V in the range of from about at least 0.68 dUg, or at least 0.70 dL/g, or at least 0.72 dUg, or at least 0.75 dUg and up to about 1.2 dL/g.

In one embodiment, the temperature applied to the polymer melt or of the polymer melt in at least a portion of the polycondensation zone is greater than 280° and up to about 290° C. In another embodiment, the temperatures in the finishing zone are, contrary to conventional practice, lower than 280° C. in order to avoid rapid increases in the rate of acetaldehyde (AA) precursor formation. The final vessel, generally known in the industry as the “high polymerizer,” “finisher,” or “polycondenser,” is also usually operated at a pressure lower than used in the prepolymerization zone to further drive off the diol and/or other byproducts and increase the molecular weight of the polymer melt. The pressure in the finishing zone may be within the range of about 0.2 to 20 mmHg, or 0.2 to 10 mmHg, or 0.2 to 2 mmHg. Although the finishing zone may typically involve the same basic chemistry as the prepolymer zone, the fact that the size of the molecules, and thus the viscosity differs, means that the reaction conditions may also differ. However, like the prepolymer reactor, each of the finishing vessel(s) may be operated under vacuum or inert gas, and each may be typically, but not necessarily mechanically, agitated to facilitate the removal of the diol and/or other byproducts.

In one aspect of the invention, the residence time of the polymer melt in finishing zone of polycondensation may be sufficient to make a polymer having an It.V. of at least 0.68 dL/g. The reaction time of the melt from an It.V. of 0.40 dUg through, and up to, an It.V. in the range of at least 0.68 dUg to 0.80 dUg may be 150 minutes or less, or 100 minutes or less, or 80 minutes or less, or 50 minutes or less. Preferably, the pressure applied within this range is about 2 mmHg or less, and about 0.05 mmHg or more.

It is to be understood that the process described above is illustrative of a melt phase process, and that the invention is not limited to this illustrative process. For example, while reference has been made to a variety of operating conditions at certain discrete It.V. values, differing process conditions may be implemented inside or outside of the stated It.V. values, or the stated operating conditions may be applied at It.V. points in the melt other than as stated. Moreover, one may adjust the process conditions based on reaction time instead of measuring or predicting the It.V. of the melt. The process is also not limited to the use of tank reactors in series or parallel or to the use of different vessels for each zone. Nor is it necessary to split the polycondensation reaction into a prepolymer zone and a finishing zone, because the polycondensation reaction can take place on a continuum of slight variations in operating conditions over time in one polycondensation reactor or in a multitude of reactors in series, either in a batch, semi-batch, or a continuous process.

Once the polymer molecular weight is built to the desired degree, it may be discharged from the final reactor, in this case a finisher, to be pelletized. A gear pump 118 may be utilized to facilitate funneling an amount of bulk polymer through a conduit 117 to exit from finishing vessel 116. A brief description of additional polymer processing 132 is described. Such additional processing 132 may include subjecting the polymer to a pelletization procedure, such as a cutting procedure through cutters 138 to form a solid, such as a chip, pellet, sphere, or any other desired shape. In some embodiments, additional processing equipment such as gear pump 136 may be employed to help process the polymer. Additional processing may further include crystallizing the solid polymer 140 to produce a finished polymer for delivery to a storage silo 134 or ready for solid state polymerization for further molecular weight buildup in the solid state after the melt phase process.

Prior to cutting the molten polymer, and in another aspect, prior to exiting the melt phase final reactor, it may be desirable to combine the bulk polymer in the melt phase with a second stream that is a liquid (which may include a molten stream, dispersions, emulsions, homogeneous liquids, and heterogeneous slurries). The second stream can be introduced into the melt phase process at any stage prior to solidification, but preferably between the cutter and the entry into the final bulk polymer reactor (such as a finisher). In one aspect of the invention, the second stream may be introduced after the last half of the residence time within the final reactor and before the cutter.

The manner in which the second liquid stream is introduced and the source of the second liquid stream is not limited. For example, it may be desirable to treat and additionally process a portion of slip stream 120. Once treated, the treated portion 129 of slip stream 120 may be circulated back to the finishing tank 116. In another example, it may be desirable to introduce the second liquid stream into the finisher 116 through an extruder or a pumping means from a source independent from or other than the bulk polymer produced in the melt phase process.

The melt phase process can typically produce aldehydes such as acetaldehyde (AA), especially in the vessel 116. AA is not desirable in bottles containing water or where the flavor of a beverage is sensitive to AA. Hence, in some instances, it may be desirable to eliminate or greatly reduce M in PET production processes.

Some polymers require the introduction of UV stabilizers to prevent the degradation of the products contained in the package. In other instances, it may also be desirable to add colorants, reheat additives, catalyst stabilizers or deactivators, or other additives depending upon the fitness for use requirements of the polymer in its ultimate application. Any one or a mixture of these additives may be contained in the second liquid stream.

The additives may be added to the molten bulk polymer stream via a slip stream or introduced from a fresh source as described above. For example, to reduce the future generation of AA upon remelting the polymer, a liquid additive such as a catalyst stabilizer supplied from a liquid additive supply tank 124, may be added to a slip stream 120 containing molten polymer produced from the melt phase production process. By stabilizing or at least partially deactivating the polymer catalyst, subsequent generation of AA can be reduced. For example, the addition of acidic phosphorus compounds to a molten polyester polymer containing active catalyst metal species, such as those based on antimony, alkali metals, alkaline earth metal or alkali earth metals, titanium, germanium, manganese, magnesium, aluminum, or mixtures thereof, are effective to control the generation of M. Low M content, as mentioned, may be preferable in the production of beverage bottles.

Additionally or alternatively, a solid additive may be added from a solid additive supply vessel 128 to the slip stream 120. Like the liquid additive 124, the solid additive from solid additive supply vessel 128 may enhance or reduce a desired effect to the slip stream 120. Additional processing equipment, such as extruder 130, may be employed to facilitate mixing the solid additive 128 into slip stream 120. The extruder 130 may also serve to provide an additional amount of mixing to the slip stream 120. The extruder may be in line with the slip stream 120, or may intersect into slip stream line 120. One or more optional gear pumps 122 may also be employed to provide motive force to the slip stream 120 as it is enriched with one or more additives. Optionally, one or more static mixers 126 in line with the slip stream line may be employed to process the slip stream 120 to provide an additional degree of mixing as desired. Thus, a treated portion 129 or additive enriched polymer slip stream may be generated and returned to the finishing tank 116 for reintroduction into the bulk polymer flow.

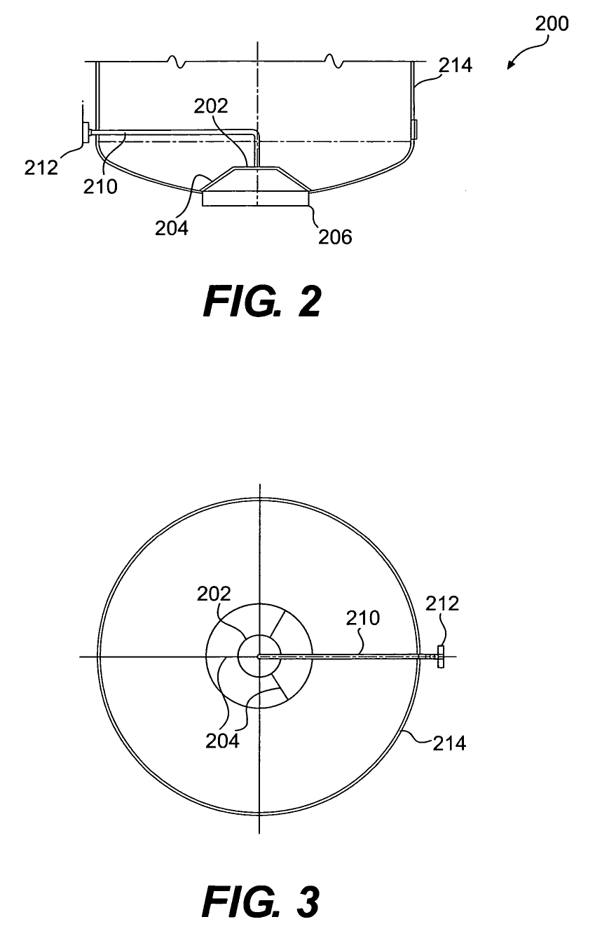

Turning to FIG. 2, a cutaway view of the finishing tank assembly 200 is shown according to an exemplary embodiment of the disclosure. The second liquid stream, optionally an additive enriched polymer stream 129, may be directed through a distributor plate assembly 202 such as via pipe 210. The pipe 210 may be configured to enter the finishing tank assembly 200 such as through sidewall 214 and coupled to the distributor plate assembly 202 as discussed below. The other end of pipe 210 may be connected to a means for supplying the second liquid stream, such as the additive enriched polymer stream 129, such as via flange 212.

In some embodiments, the distributor plate assembly 202 may be retained within the finishing tank assembly 200 via rigid supports 204. The material of the distributor plate assembly 202 is not particularly limited and will depend upon the application. It may comprise a high alloy metal such as Hastelloy™. Other non-corrosive materials resistant, for example, to polymer and additive enriched polymer streams, may be utilized for the distributor plate assembly 202. Stainless steel may be used in non-corrosive environments. The rigid supports couple distributor plate assembly 202 to points of the finishing tank assembly 200, such as those located on sidewalls 214. The rigid supports may be preferably welded to the distributor plate assembly 202 and the finishing tank assembly 200.

As the bulk polymer flow flows into the outlet 206 of the finishing tank assembly 200, a design of the distributor plate assembly 202 may include enabling the second liquid stream 129 to mix into the bulk polymer flow stream at various locations as described below. An enhanced bulk polymer flow stream into which a second liquid stream is combined may be delivered from the outlet 206 of the final polymer reactor, such as the finishing tank assembly 200.

The second liquid stream may be a solution or heterogeneous combination of ingredients. The second liquid stream can be a dispersion, emulsion, slurry, or a solution as fed into the bulk polymer. The flow may be two phase or single phase.

Turning to FIG. 7, a completed assembly of the distributor plate assembly 202 is shown. The distributor plate assembly 202 comprises two distributor plates, namely, top distributor plate 400 and bottom distributor plate 500. The top distributor plate 400 and bottom distributor plate 500 may be mated together to form a joined and final distributor plate assembly 202. In some embodiments, the top distributor plate 400 and bottom distributor plate 500 may be welded together. Any conventional fastening technique sufficient to prevent leakage of the second liquid stream from the edges of the plate assembly may be employed.

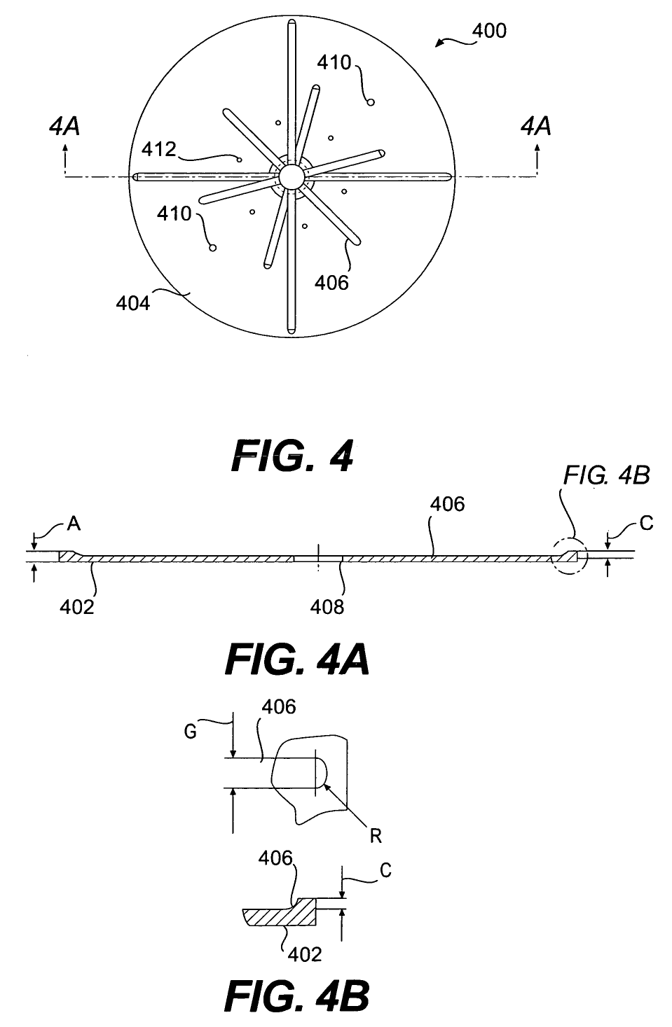

Turning to FIG. 4, a bottom view of the top distributor plate 400 is shown. A plurality of grooved channels 406 are formed on an inner surface 404 of the top distributor plate 400. In some embodiments, a cross-sectional shape of channels 406 may comprise a semi-circular design. However, it should be readily understood that a cross-sectional shape of channels 406 may include a multitude of designs conducive for receiving and allowing materials to flow therethrough. In one embodiment, the aforementioned material may include viscous material (e.g., having a viscosity greater than 500 cP). A measurement of viscosity for viscous materials may be in conformance with Standards Organizations, such as ASTM International, for measuring viscosity. However, the invention, described herein, shall not be limited to utilizing only viscous material(s).

One or more alignment holes 410 may also be provided on the top distributor plate 400 to facilitate alignment and assembly of the distributor plate assembly 202 as described below. Additionally, one or more weld point holes 412 may be provided on the top distributor plate 400. These one or more holes may facilitate forming weld points in the interior of the distributor plate assembly 202 as described below.

Turning to FIG. 4A, a side view of the top distributor plate 400 is shown. The top distributor plate 400 is shown having a thickness A. In one embodiment, the thickness may be about ½ inch. A connection hole 408 is formed in an outer surface 402 of the top distributor plate 400. The connection hole 408 is in communication with each channel 406. Channel 406 may comprise a depth C. In one embodiment, the depth of channel 406 may be about, in inches, at least 0.01, or at least 0.05, or at least 0.1, and up to about 2, or up to 1, or up to 0.5, and in another embodiment, the depth of the channel 406 is about ¼ inch.

Turning to FIG. 4B, channel 406 may comprise a width G. In one embodiment, the width of channel 406 may be, in inches, at least 0.05, or at least 0.1, or at least 0.25 and up to about 2, or up to 1, or up to 0.75, and in another embodiment, the width G of the channel 406 is about ½ inch. The dimensions of the length, width, and height of each channel 406 formed in the inner surface 404 may vary in accordance with a preferred design.

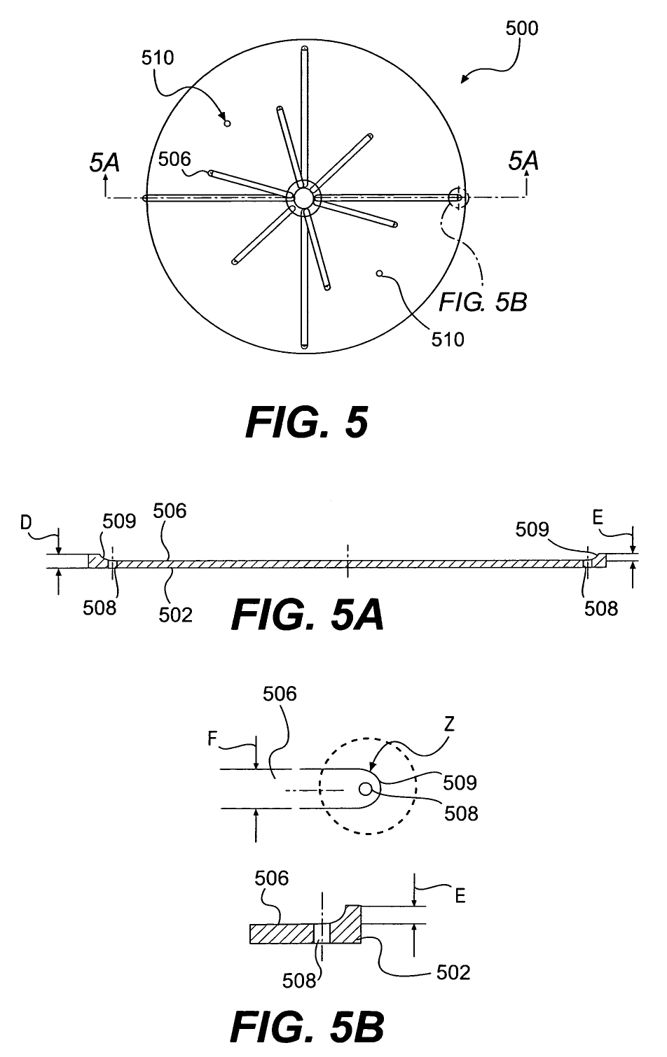

Turning to FIG. 5, a top view of the bottom distributor plate 500 is shown. A plurality of grooved channels 506 are formed on an inner surface 504 of the bottom distributor plate 500. A plurality means at least two. In some embodiments, a cross-sectional shape of channels 506 may comprise a semi-circular design. However, it should be readily understood that a cross-sectional shape of channels 506 may include a multitude of designs conducive for receiving and allowing materials, such as viscous materials (e.g., having a viscosity greater than 500 cP), to flow therethrough. One or more alignment pins 510 may be provided on the bottom distributor plate 500 to facilitate alignment and assembly of the distributor plate assembly 202 as described below.

Turning to FIG. 5A, a side view of the bottom distributor plate 500 is shown. The bottom distributor plate 500 is shown having a thickness D. In one embodiment, the thickness may be about ½ inch. Channel 506 may comprise a depth E. In one embodiment, the depth of channel 506 may be about ¼ inch.

Turning to FIG. 5B, channel 506 may comprise a width F. In one embodiment, the width of channel 506 may be about ½ inch. The dimensions of the length, width, and height of each channel 506 formed in the inner surface 504 may vary in accordance with a preferred design.

FIGS. 5A-5B also depict outlet holes 508 disposed approximately at respective distal ends 509 of each channel 506. It is to be understood that more than one outlet hole per channel may be provided. In some embodiments, outlet holes 508 extend from each channel 506 to and through outer surface 502 of the bottom distributor plate 500. The outlet holes 508 allow material, such as viscous materials (e.g., having a viscosity greater than 500 cP), within each channel 506 to exit from the outer surface 502 of the bottom distributor plate 500. Since, the length of each channel may vary according to some embodiments, outlet holes 508 may be provided at varying locations beneath the bottom distributor plate 500. It should be readily understood that the specific location of outlet holes 508 being disposed at distal ends 509 of each channel 506 is exemplary and should not be viewed as limiting the invention. In additional embodiments, for example, one or more outlet holes 508 may be disposed along the length of each channel 506, and each channel may be of any desired length, with the lengths among two or more of the channels also varying.

Not each channel must have an outlet hole located at the distal end of the channel. In one embodiment, the outlet holes 508 are located at the distal ends of at least 25%, or at least 50%, or at least 70%, or at least 90% of the channels of the second plate. In another embodiment, the outlets are located at the distal ends of at least 25%, or at least 50%, or at least 70%, or at least 90% of the enclosed channels. In another embodiment, the outlet holes are located at the distal ends of all channels or enclosed channels, and in yet another embodiment, at least 50% of the channels have only one outlet hole, said outlet hole located at the distal end of the channels or enclosed channel.

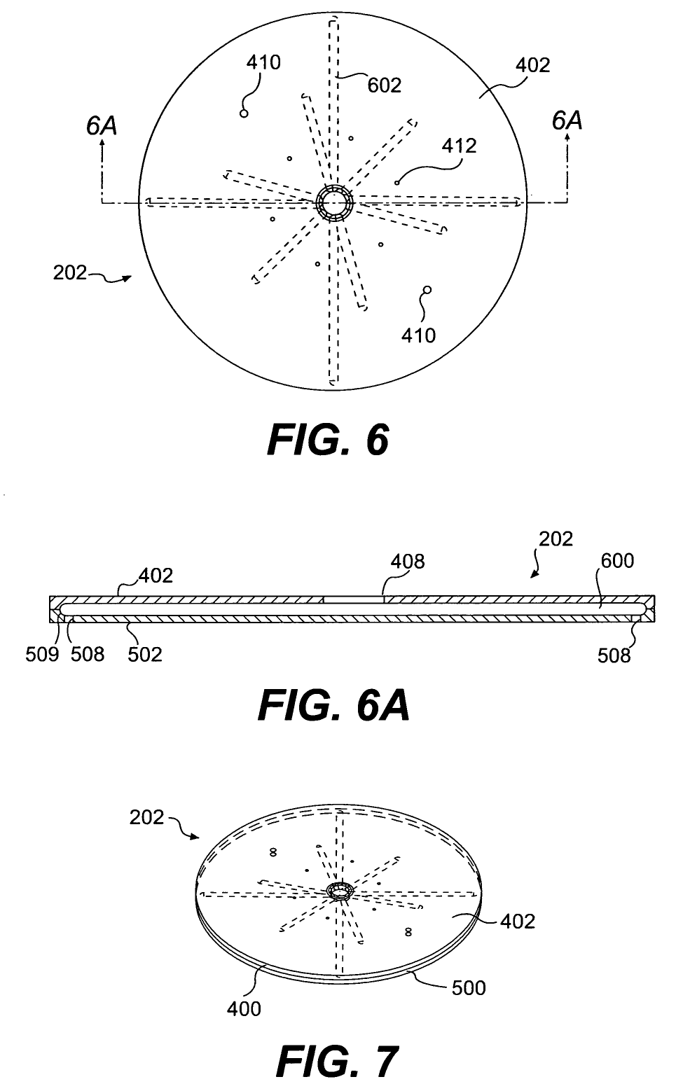

In another embodiment, the top distributor plate 400 may be mated such that at least two of the channels 406, or each of the channels 406 are aligned with corresponding respective channels 506 of the bottom distributor plate 500 to form enclosed channels 600. Turning to FIG. 6, a top view of distributor plate assembly 202 illustrates each channel 406 of the top distributor plate 400 corresponding in location and dimension to a respective channel 506 located in the bottom distributor plate 500 to form fully enclosed channels 600. The distributor plate may have at least two enclosed channels 600, or at least three, or at least four, or at least five, or at least six, or at least seven, or at least eight. There is no particular upper limit. For example, one thousand channels may be provided. However, for many applications, not more than fifty, or not more than forty, or not more than twenty, or not more than fifteen channels would be needed. The aforementioned assembly inherently allows connection hole 408 to be in liquid communication with channels 506 since each of the channels 406 are aligned with corresponding respective channels 506. Not all of the channels 406 or 506, however, need to be aligned, but preferably each of the channels is aligned.

One mechanism for aligning channels 406 and 506 together may include utilizing alignment holes 410 of the top distributor plate 400 such that they align with alignment pins 510 of the bottom distributor plate 500. In some embodiments, the location of the alignment holes 410 and alignment pins 510 of top and bottom distributor plates 400 and 500 respectively, correspond to prescribed locations of channels 406 and 506 of top and bottom distributor plates 400 and 500, respectively. When alignment holes 410 and alignment pins 510 of top and bottom distributor plates 400 and 500 are aligned, top and bottom distributor plates 400 and 500 may be permanently attached. Attachment may include welding or any other securing means for rigidly attaching the distributor plates 400 and 500 together.

Assembled in the described manner, channels 406, 506 form fully enclosed channels 600 enabled to receive material such as via connection hole 408 as shown, for instance, in FIGS. 6-6A. In operation, a supply of material may be coupled to connection hole 408 (in communication with the now fully formed channels 600). As material enters through the connection hole 408, the material enters and fills each fully enclosed channel 600. Once the material reaches outlet holes 508, the material can exit accordingly through outlet holes 508 to and through outer surface 502 of bottom distributor plate 500. Assembled, for example, within a bulk polymer flow stream, the distributor plate assembly 202 can receive a second liquid stream comprising an additive enriched polymer stream 129 (such as one supplied and coupled to connection hole 408), disperse the additive enriched polymer stream 129 through enclosed channels 600 of the distributor plate assembly 202, and distribute the additive enriched polymer stream 129 to varying positions of the bulk polymer flow stream from respective outlet holes 508.

Weld point holes 412 provide access to an interior of the assembled distributor plate assembly 202. Weld points may be formed at interior locations such as through weld point holes 412 to provide additional rigid connection between the top and bottom distributor plates 400 and 500. Formation of the weld points may prevent buckling of the top and bottom distributor plates 400 and 500 as a result of increased pressure from the material once it enters enclosed channels 600. This may also prevent leakage of the material from within enclosed channels 600.

Although an example of the distributor plate assembly 202 is described distributing an additive enriched polymer stream into a bulk polymer flow stream, it will be appreciated that other materials, for example, of one prescribed viscosity, may be distributed into a bulk flow stream of another material having, for example, another prescribed viscosity. By way of example, other materials which may be utilized as additives within the chemical, pharmaceutical, food, water, and polymer processing industries include a colorant, a pigment, a carbon black or graphite, a glass fiber, an impact modifier, an antioxidant, a surface lubricant, a denesting agent, a UV light absorbing agent, a metal or catalyst deactivator, a filler, a nucleating agent, an impact modifier, a catalyst stabilizer or other agent to stabilize against thermal degradation or polymer discoloration, a flame retardant, a reheat aid, a crystallization aid, a compound to reduce the amount of residual acetaldehyde or reduce or retard formation of acetaldehyde generation species, a recycling release aid, an oxidizable material for scavenging oxygen, a platelet particle, amino acids, glycerin lower fatty acid esters, sugar esters, salts of vitamin B1, polyphosphates, ethanol, basic proteins and peptides, antibacterial extract from licorice, extract from red pepper, extract from hop, extract from yucca, extract from moso bamboo (thick-stemmed bamboo), extract from grapefruit seed, extract from wasabi (Japanese horseradish) or mustard, acetic acid, lactic acid, fumaric acid and the salts thereof, sorbic acid, benzoic acid and the salts and esters thereof, propionic acid and the salt thereof, chitosan and bacterium DNA, cyclohexane dimethanol, trimellitic anhydryde and other cross-linking agents, and a mixture thereof.

The composition or nature of the polymer in the bulk polymer composition may or may not be the same as one of the ingredients in the second liquid stream. For example, both the polymer in the bulk polymer stream may be the same as the polymer in the second liquid stream in the sense as having the same repeating structural unit, although the molecular weight and order of the repeating monomers may vary. In one embodiment, the second liquid stream comprises a compound, oligomer, or polymer having an Mn molecular weight ranging from 50 to 100,000. The compound may be reactive with the polymer in the bulk polymer stream so as to react into the backbone of the polymer in the bulk stream, whether through end to end reaction or trans reactions. Examples may include ethylene glycol, polyoxyalkylene polyols, crosslinking agents, chain extenders, polyethylene, polypropylene, polyurethane, polycarbonate, polyesters, compounds having acrylic or vinyl functionality, and other compounds or polymers or oligomers having cyano, nitrile, carbamate, hydroxyl, carbonyl, or other functionality.

Also, although the distributor plate assembly 202 is shown and described with certain dimensions and location of features, such as channels 406, 506 and outlet holes 508, such dimensions and location of features may be adjusted, for example, to affect a mass flow of material from the distributor plate assembly 202 and/or to affect a pressure drop in the distributor plate assembly 202. For example, various embodiments of dimensions may include adjusting a height, width, and/or diameter of channels 406, 506, and outlet holes 508 to balance pressure within enclosed channels 600 in accordance with a prescribed mass profile of material which may be received through connection hole 408 and distributed throughout fully enclosed channels 600.

In another embodiment, there is provided a process for distributing an additive enriched second material into a flow of a first material which may comprise a flow of a first material within a vessel and feeding the first material into one or more openings on a distributor located within a vessel without comingling the feed of the second material with the first material within the vessel. The process may also include the second material flowing through two or more of a plurality of channels within the distributor and being released through outlets located at various locations on the distributor into a liquid stream of the first material, wherein the number of outlets exceeds the number of openings on the distributor.

In the process, the distributor may comprise a first plate having an inner surface and an outer surface, the outer surface having an opening for receiving the second material, the inner surface having a plurality of channels disposed therein, wherein at least one of the channels of the first plate is in communication with the opening, and a second plate connected to the first plate, the second plate having an inner surface and an outer surface, the inner surface of the second plate having a plurality of channels disposed therein, wherein at least one of the plurality of channels of the second plate are aligned with said plurality of channels of the first plate to form enclosed channels in communication with the opening. Desirably, at least one of the plurality of channels of said second plate may have outlet holes, wherein the outlets extend from at least one of the channels of the second plate to the outer surface of the second plate.

In another aspect of the invention, the dimensions of the plurality of channels and the outlets may be set to affect a pressure drop between the inlet to the distributor and the outlet holes. The number of enclosed channels and the location of the enclosed channels may be desirably set to affect distribution of the second material based on a mass flow profile of the first material. In the process of the invention, the distributor may be preferably static, meaning that the distributor has no rotating parts within the distributor plate to move the second liquid composition through the channels.

In some embodiments, the process may further include feeding a second material containing an additive into an inlet of a vessel through a pipe coupled to an opening on the distributor located within the vessel, a flow of a first material within a vessel, and feeding the first material into one or more openings on a distributor located within a vessel without comingling the feed of the second material with the first material within the vessel. The process may also include the second material flowing through two or more of a plurality of channels within the distributor and being released through outlets located at various locations on the distributor into a liquid stream of the first material, wherein the number of outlets exceeds the number of openings on the distributor.

An apparatus may be provided that, in some embodiments, may include a first plate having an inner surface and an outer surface, the outer surface having an opening for receiving the second material, the inner surface having a plurality of channels disposed therein, wherein the plurality of channels is in communication with the opening. The apparatus may further include a second plate connected to the first plate to form a distribution plate assembly, the second plate having an inner surface and an outer surface, the inner surface of the second plate having a plurality of channels disposed therein, wherein at least two of the channels of the second plate are aligned with at least two of the channels of the first plate to form two or more enclosed channels in communication with the opening, and at least two of the plurality of channels of the second plate extend to outlet(s) on the outer surface of the second plate. The second material may comprise an additive comprising a colorant, pigment, UV light absorbing agent, catalyst stabilizer, catalyst deactivator, reheat aid, acetaldehyde reducing compound, or an oxidizable material for oxygen scavenging, or mixtures thereof.

In some embodiments, the second material may further comprise said additive and a second polymer, and the first material may comprise a polymer having the same structural formula as the second polymer.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for distributing a second material into a flow stream of a first material comprising:
a first plate having an inner surface and an outer surface, the outer surface having an opening for receiving the second material, the inner surface having a plurality of channels disposed therein, wherein said plurality of channels is in communication with the opening;
a second plate connected to the first plate to form a distribution plate assembly, said second plate having an inner surface and an outer surface, the inner surface of the second plate having a plurality of channels disposed therein, wherein at least two of said channels of the second plate are aligned with at least two of said channels of the first plate to form two or more enclosed channels in communication with the opening, and at least two of said plurality of channels of said second plate extend to outlet(s) on the outer surface of the second plate.

2. The apparatus of claim 1, further comprising:
at least one alignment hole disposed in the first plate; and
at least one corresponding alignment pin disposed in the second plate.

3. The apparatus of claim 1, further comprising:
one or more weld point holes disposed on the first plate.

4. The apparatus of claim 1, wherein the outlets are located approximately at distal ends of at least two of the plurality of channels of the second plate.

5. The apparatus of claim 4, wherein the outlets are located at the distal ends of at least 70% of the plurality of channels of the second plate.

6. The apparatus of claim 5, wherein the outlets are located at the distal ends of at least 70% of the enclosed channels.

7. The apparatus of claim 5, wherein the outlets are located at the distal ends of at least 90% of the plurality of channels of the second plate.

8. The apparatus of claim 7, wherein the outlets are located at the distal ends of at least 90% of the enclosed channels.

9. The apparatus of claim 5, wherein the outlets are located at the distal ends of all the plurality of channels of the second plate.

10. The apparatus of claim 9, wherein the outlets are located at the distal ends of all the enclosed channels.

11. The apparatus of claim 1, wherein one or more of the plurality of channels of the first plate differ in length from the remaining plurality of channels of the first plate.

12. The apparatus of claim 1, wherein one or more of the plurality of channels of the second plate differ in length from the remaining plurality of channels of the second plate.

13. The apparatus of claim 1, wherein dimensions of the plurality of channels of the first plate, the plurality of channels of the second plate, and the outlets are set to affect a pressure drop in the distribution plate assembly.

14. The apparatus of claim 1, wherein the number of enclosed channels and the location of the enclosed channels are set to affect distribution of the second material based on a mass flow profile of the first material.

15. The apparatus of claim 1, wherein the first plate and the second plate comprise a high alloy metal.

16. The apparatus of claim 1, wherein the first plate and the second plate are welded together.

17. The apparatus of claim 1, wherein the distribution plate assembly is mounted in a reactor for processing a liquid stream.

18. The apparatus of claim 1, wherein the second material comprises an additive enriched polymer.

19. The apparatus of claim 1, wherein the first material comprises a polymer selected from polyesters, polyamides, polyurethanes, polyolefins and poly(ethylene terephthalate) or a copolymer thereof.

20. The apparatus of claim 1, wherein the second material comprises an additive comprising a colorant, pigment, carbon black, glass fiber, impact modifier, antioxidant, surface lubricant, denesting agent, UV light absorbing agent, catalyst stabilizer, catalyst deactivator, filler, impact modifier, nucleating agent, stabilizer, flame retardant, reheat aid, crystallization aid, acetaldehyde reducing compound, recycling release aid, oxidizable material for oxygen scavenging platelet particle, amino acids, glycerin lower fatty acid esters, sugar esters, salts of vitamin B1, polyphosphates, ethanol, basic proteins and peptides, antibacterial extract from licorice, extract from red pepper, extract from hop, extract from yucca, extract from moso bamboo (thick-stemmed bamboo), extract from grapefruit seed, extract from wasabi (Japanese horseradish) or mustard, acetic acid, lactic acid, fumaric acid and the salts thereof, sorbic acid, benzoic acid and the salts and esters thereof, propionic acid and the salt thereof, chitosan and bacterium DNA, cyclohexane dimethanol, trimellitic anhydride, cross-linking agents other than trimellitic anyhydride, or mixtures thereof.

21. The apparatus of claim 1, wherein the second material comprises an additive comprising a colorant, pigment, UV light absorbing agent, catalyst stabilizer, catalyst deactivator, reheat aid, acetaldehyde reducing compound, or an oxidizable material for oxygen scavenging, or mixtures thereof.

22. The apparatus of claim 21, wherein the second material comprises said additive and a second polymer, and the first material comprises a polymer having the same structural formula as said second polymer.

23. A system for processing a liquid stream comprising:
a first material;
a vessel containing said first material;
an inlet into said vessel for feeding a second material; and
a distributor for distributing said second material coupled directly or indirectly to said inlet, said distributor distributing said second material at various locations into a liquid stream of the first material, said distributor mounted within the vessel.

24. The system of claim 23, wherein the distributor comprises a first plate having an inner surface and an outer surface, the outer surface having an opening for receiving the second material, the inner surface having a plurality of channels disposed therein, wherein at least two of the channels of the first plate is in communication with the opening, and a second plate connected to the first plate, said second plate having an inner surface and an outer surface, the inner surface of the second plate having a plurality of channels disposed therein, wherein at least two of the plurality of channels of the second plate are aligned with said plurality of channels of the first plate to form enclosed channels in communication with the opening, at least two of said plurality of channels of said second plate further comprising outlets, wherein the outlets extend from at least two of the channels of the second plate to the outer surface of the second plate.

25. The system of claim 24, wherein the outlets are located approximately at the distal ends of at least two of the channels of the second plate.

26. The system of claim 24, wherein one or more of the plurality of channels of the first plate differ in length from the remaining plurality of channels of the first plate.

27. The system of claim 24, wherein one or more of the plurality of channels of the second plate differ in length from the remaining plurality of channels of the second plate.

28. The system of claim 24, wherein dimensions of the plurality of channels of the first plate, the plurality of channels of the second plate, and the outlets are set to affect a pressure drop in the distribution plate assembly.

29. The system of claim 24, wherein the number of enclosed channels and the location of the enclosed channels are set to affect distribution of the second material based on a mass flow profile of the first material.

30. The system of claim 24, wherein the first plate and the second plate comprise a high alloy metal.

31. The system of claim 24, wherein the first plate and the second plate are fastened together.

32. The system of claim 24, wherein the distribution plate assembly is fastened to the vessel.

33. The system of claim 23, wherein the first material comprises a polymer comprising a polyester, polyamide, polyurethane, polyolefin, poly(alkylene terephthalate), poly(alkylene naphthalate), or copolymers thereof, or mixtures thereof.

34. The system of claim 23, wherein the second material comprises an additive enriched polymer.

35. The system of claim 23, wherein the vessel comprises a melt phase polymer reactor.

36. The system of claim 35, wherein reactor is the last reactor vessel in a melt phase polyester polymerization process for increasing the molecular weight of a polyester polymer under vacuum.

37. The system of claim 23, wherein a piping assembly connects the inlet of the vessel to the distributor.

38. The system of claim 37, wherein the piping assembly is coupled to the opening of the outer surface of the first plate.

39. The system of claim 24, further comprising:
ports for accessing weld points in the interior of the distributor.

40. The system of claim 30, wherein the ports comprise weld point holes disposed on the first plate.

41. A process for distributing an additive enriched second material into a flow of a first material comprising:
a. a flow of a first material within a vessel;
b. feeding the second material into one or more openings on a distributor located within a vessel without comingling the feed of the second material with the first material within the vessel;
c. said second material flowing through two or more of a plurality of channels within the distributor and being released through outlets located at various locations on the distributor into a liquid stream of the first material, wherein the number of outlets exceeds the number of openings on the distributor.

42. The process of claim 41, wherein the distributor comprises a first plate having an inner surface and an outer surface, the outer surface having an opening for receiving the second material, the inner surface having a plurality of channels disposed therein, wherein at least one of the channels of the first plate is in communication with the opening, and a second plate connected to the first plate, said second plate having an inner surface and an outer surface, the inner surface of the second plate having a plurality of channels disposed therein, wherein at least one of the plurality of channels of the second plate are aligned with said plurality of channels of the first plate to form enclosed channels in communication with the opening, at least one of said plurality of channels of said second plate further comprising outlets, wherein the outlets extend from at least one of the channels of the second plate to the outer surface of the second plate.

43. The process of claim 41, wherein the dimensions of the plurality of channels and the outlets are set to affect a pressure drop in the distributor.

44. The process of claim 41, wherein the number of enclosed channels and the location of the enclosed channels are set to affect distribution of the second material based on a mass flow profile of the first material

45. The process of claim 41, wherein the first material comprises a first polymer, and the second material comprises an additive and a second polymer.

46. The process of claim 45, wherein said additive comprises a colorant, pigment, carbon black, glass fiber, impact modifier, antioxidant, surface lubricant, denesting agent, UV light absorbing agent, catalyst stabilizer, catalyst deactivator, filler, nucleating agent, impact modifier, stabilizer, flame retardant, reheat aid, crystallization aid, acetaldehyde reducing compound, recycling release aid, oxidizable material for oxygen scavenging platelet particle, amino acids, glycerin lower fatty acid esters, sugar esters, salts of vitamin B1, polyphosphates, ethanol, basic proteins and peptides, antibacterial extract from licorice, extract from red pepper, extract from hop, extract from yucca, extract from moso bamboo (thick-stemmed bamboo), extract from grapefruit seed, extract from wasabi (Japanese horseradish) or mustard, acetic acid, lactic acid, fumaric acid and the salts thereof, sorbic acid, benzoic acid and the salts and esters thereof, propionic acid and the salt thereof, chitosan and bacterium DNA, cyclohexane dimethanol, trimellitic anhydride, cross-linking agents other than trimellitic anyhydride, or mixtures thereof.

47. The process of claim 45, wherein the first polymer comprises a polyester, polyamide, polyurethane, polyolefin, poly(alkylene terephthalate), poly(alkylene naphthalate), or copolymers thereof, or mixtures thereof.
